(19) United States
(12) Patent Application Publication
(10) Pub. No.: US 2021/0096232 A1
(43) Pub. Date: Apr. 1, 2021

(54) DISTANCE MEASUREMENT METHODS AND APPARATUSES, AND UNMANNED AERIAL VEHICLES

(71) Applicant: SZ DJI TECHNOLOGY CO., LTD., Shenzhen (CN)

(72) Inventors: You ZHOU, Shenzhen (CN); Jiebin XIE, Shenzhen (CN); Xiaoming WANG, Shenzhen (CN)

(73) Assignee: SZ DJI TECHNOLOGY CO., LTD., Shenzhen (CN)

(21) Appl. No.: 17/120,481

(22) Filed: Dec. 14, 2020

Related U.S. Application Data
(63) Continuation of application No. PCT/CN2018/097291, filed on Jul. 26, 2018.

(51) Int. Cl. G01S 13/08; G01S 7/40; B64C 39/02

(52) U.S. Cl. CPC G01S 13/08; G01S 7/40; B64C 2201/12; B64C 2201/027; B64C 39/024

(57) ABSTRACT

A distance measurement method and apparatus, and an unmanned aerial vehicle are provided. The method includes: after obtaining a distance measurement value corresponding to a returned distance measurement signal, determining target strength of the distance measurement signal based on the distance measurement value; and determining a distance result value based on received strength of the distance measurement signal, the target strength, and the distance measurement value. The present disclosure improves the accuracy of a distance measurement result.

### RELATED APPLICATIONS

This application is a continuation application of PCT application No. PCT/CN2018/097291, filed on Jul. 26, 2018, and the content of which is incorporated herein by reference in its entirety.

### TECHNICAL FIELD

The present disclosure relates to the technical field of unmanned aerial vehicles, and in particular, to a distance measurement method and apparatus, and an unmanned aerial vehicle.

### BACKGROUND

Currently, an unmanned aerial vehicle mainly uses a distance measurement module to sense an ambient environment, for example, perform height measurement.

Generally, a relative distance measurement module is used to measure a relative distance, for example, measure a distance from an obstacle, or a height relative to the ground. During height measurement, because a barometer may not be very accurate, and a height provided by a global positioning system (Global Positioning System, GPS) may also have an error, a relative distance measurement module is typically used to measure a relative height. For example, a time of flight (Time of flight, ToF) distance measurement module or an ultrasonic distance measurement module may be used to measure a height relative to the ground, so as to provide observations in landing and takeoff processes. However, the relative distance measurement module is environment-sensitive. For example, in a rainy, snowy, or smoggy weather, as laser may encounter a particle (for example, a smog particle, a rain drop, or a snowflake) in the air and is reflected to some extent, the ToF distance measurement module receives the laser reflected by a particle nearby, and thus generates an incorrect report, for example, it may incorrectly sense that there is a high building below, and accordingly a flight strategy may be affected.

Therefore, there is a problem of inaccurate distance measurement in the field.

### SUMMARY

The present disclosure provides a distance measurement method and apparatus, and an unmanned aerial vehicle, which can solve the problem of inaccurate distance measurement results.

In a first aspect, the present disclosure provides a distance measurement apparatus, including: a distance measurement module to obtain, based on a returned distance measurement signal, a distance measurement value corresponding to the distance measurement signal; and a processor, to: determine target strength of the distance measurement signal based on the distance measurement value after the distance measurement module obtaining the distance measurement value corresponding to the distance measurement signal, and determine a distance result value based on received strength of the distance measurement signal, the target strength, and the distance measurement value.

In a second aspect, the present disclosure provides an unmanned aerial vehicle, including a distance measurement module to obtain, based on a returned distance measurement signal, a distance measurement value corresponding to the distance measurement signal; a processor to determine target strength of the distance measurement signal based on the distance measurement value after obtaining, from the distance measurement module through the communication interface, the distance measurement value corresponding to the distance measurement signal, and determine a distance result value based on received strength of the distance measurement signal, the target strength, and the distance measurement value; and a communication interface.

In a third aspect, the present disclosure provides a distance measurement method, including determining, by a processor of a distance measurement apparatus, target strength of a distance measurement signal based on a distance measurement value, after obtaining the distance measurement value corresponding to a returned distance measurement signal; and determining a distance result value based on a received strength of the distance measurement signal, the target strength, and the distance measurement value.

Exemplary embodiments of the present disclosure provide a distance measurement method and apparatus, and an unmanned aerial vehicle. After the distance measurement value corresponding to the returned distance measurement signal is obtained, the target strength of the distance measurement signal may be determined based on the distance measurement value, and the distance result value may be determined based on the received strength of the distance measurement signal, the target strength, and the distance measurement value. Because the target strength and the received strength of the distance measurement signal may reflect the accuracy of the distance measurement value, the distance result value that is more accurate than the distance measurement value may be determined based on the received strength of the distance measurement signal, the target strength, and the distance measurement value. Therefore, the accuracy of a distance measurement result is improved.

### BRIEF DESCRIPTION OF THE DRAWINGS

To describe the technical solutions in the embodiments of the present disclosure more clearly, the following briefly describes the accompanying drawings for describing the exemplary embodiments. Apparently, the accompanying drawings in the following description show some exemplary embodiments of the present disclosure, and a person of ordinary skill in the art may still derive other drawings from these accompanying drawings without creative efforts.

FIG. 1A is a schematic diagram of parameters according to some exemplary embodiments of the present disclosure;

FIG. 1B is a schematic diagram of a relationship between a distance and illuminance according to some exemplary embodiments of the present disclosure;

FIG. 2 is a flowchart of a distance measurement method according to some exemplary embodiments of the present disclosure;

FIG. 3 is a flowchart of a distance measurement method according to some exemplary embodiments of the present disclosure;

FIG. 4 is a schematic diagram of a target range according to some exemplary embodiments of the present disclosure;

FIG. 5 is a flowchart of a distance measurement method according to some exemplary embodiments of the present disclosure;

FIG. 6 is a schematic diagram of a distance measurement method according to some exemplary embodiments of the present disclosure;

FIG. 7 is a schematic structural diagram of a distance measurement apparatus according to some exemplary embodiments of the present disclosure;

FIG. 8 is a schematic structural diagram of a distance measurement apparatus according to some exemplary embodiments of the present disclosure;

FIG. 9 is a schematic structural diagram of an unmanned aerial vehicle according to some exemplary embodiments of the present disclosure; and

FIG. 10 is a physical structural diagram of an unmanned aerial vehicle according to some exemplary embodiments of the present disclosure.

### DETAILED DESCRIPTION OF THE DRAWINGS AND THE PRESENTLY PREFERRED EMBODIMENTS

To make the objects, technical solutions, and advantages of exemplary embodiments of the present disclosure clearer, the following clearly describes the technical solutions in the embodiments of the present disclosure with reference to the accompanying drawings in the exemplary embodiments of the present disclosure. Apparently, the described embodiments are some but not all of the embodiments of the present disclosure. Other embodiments obtained by a person of ordinary skill in the art based on the exemplary embodiments of the present disclosure without creative efforts shall fall within the scope of protection of the present disclosure.

Unless otherwise defined, meanings of all technical and scientific terms used in the specification are the same as those generally understood by a person skilled in the art of the present disclosure. The terms used in the specification of the present disclosure herein are used only to describe specific embodiments, and not intended to limit the present disclosure. The term “and/or” used in the specification includes any or all possible combinations of one or more associated listed items.

The following describes in detail some exemplary embodiments of the present disclosure with reference to the accompanying drawings. Under a condition that no conflict occurs, the following embodiments and features in the embodiments may be combined.

The embodiments of the present disclosure may be applied to any scenario in which a relative distance is measured. In some exemplary embodiments, some embodiments of the present disclosure may be applied to measurement of a relative distance of an unmanned aerial vehicle. For example, a height of the unmanned aerial vehicle relative to the ground is measured, or a relative distance between the unmanned aerial vehicle and an obstacle is measured. A distance measurement module may be mounted on the unmanned aerial vehicle, and the distance measurement module may measure a relative distance. Specifically, after transmitting a distance measurement signal, the distance measurement module receives the distance measurement signal returned by the ground or an obstacle, and obtains a relative distance based on the distance measurement signal returned by the ground or the obstacle. However, when there are particles such as smog particles, rain drops, and snowflakes in the air, the distance measurement signal may be reflected by a particle to some extent, and thus the distance measurement module may receive the distance measurement signal returned by the particle. As a result, this may cause a problem that a measurement result of the distance measurement module is inaccurate.

It should be noted that the distance measurement module may be at least one of the following: an ultrasonic distance measurement module, a ToF distance measurement module, an infrared distance measurement module, a lidar distance measurement module, and a millimeter-wave radar distance measurement module.

In some exemplary embodiments of the present disclosure, it is determined, based on theoretical analysis, that a relationship exists between a relative distance and the strength of a returned distance measurement signal received. Specifically, based on photometry, the illuminance E at a distance of r from a point light source S is inferred as follows:

First, a formula (3) is obtained based on the following formula (1) and formula (2):

$$\begin{matrix}I = \frac{d φ}{d Ω} & formula ( 1 ) \\ d Ω = \frac{cos θ \cdot dA}{{r}^{2}} & formula ( 2 ) \\ d φ = \frac{I cos θ \cdot dA}{{r}^{2}} & formula ( 3 )\end{matrix}$$

The formula (3) is then substituted into the following formula (4), and a formula (5) is obtained:

$$\begin{matrix}E = \frac{d φ}{d A} & formula ( 4 ) \\ E = \frac{\frac{I cos θ \cdot dA}{{r}^{2}}}{d A} = \frac{I}{{r}^{2}} cos θ & formula ( 5 )\end{matrix}$$

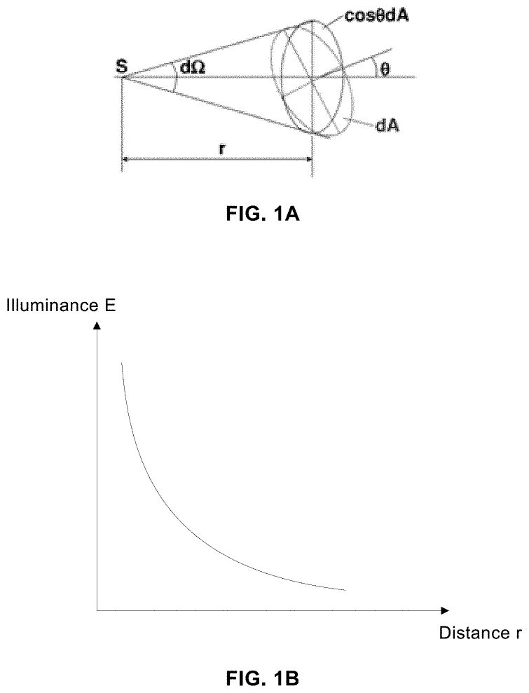

In the formula (1) to the formula (5), I is radiant intensity, dϕ is a radiant flux, dΩ is an elementary solid angle, dA is an elementary area, and θ is an angle between a radiant surface whose elementary area is dA and a surface normal vector, where r, dΩ, dA, θ, and cosθdA may be referred to FIG. 1A.

As can be known based on the formula (5), a relationship between a distance and an illuminance is that the illuminance is in inverse proportion to a square of the distance. Specifically, as shown in FIG. 1 B, as the distance r increases, the illuminance gradually decreases. As can be seen, when light is transmitted in an air medium, illuminance of the light decreases regularly. When applied in a distance measurement module, the energy of a distance measurement signal sent by the distance measurement module also decreases regularly along its continuous transmission in the air medium. Therefore, after the distance measurement module sends the distance measurement signal, a specific relationship exists between the strength of the returned distance measurement signal received and the relative distance. In some exemplary embodiments, the strength of the returned distance measurement signal received may be in inverse proportion to a square of the relative distance.

In some exemplary embodiments, for a specific distance measurement module, an existing relationship between the strength of a returned distance measurement signal received and a distance may be obtained from a data manual provided by a manufacturer or from an experiment. That is, for a determined distance, the corresponding target strength should exist. In some exemplary embodiments, a relationship shown in FIG. 1B may also exist between the strength of a returned distance measurement signal received and a relative distance. For a determined relative distance r₀, the corresponding target strength E₀ should exist.

Therefore, in some exemplary embodiments of the present disclosure, after a distance measurement value corresponding to a returned distance measurement signal is obtained, the target strength corresponding to the distance measurement value may be determined, and an accurate measurement result is finally obtained based on the distance measurement value, the strength of the distance measurement signal received, and the target strength.

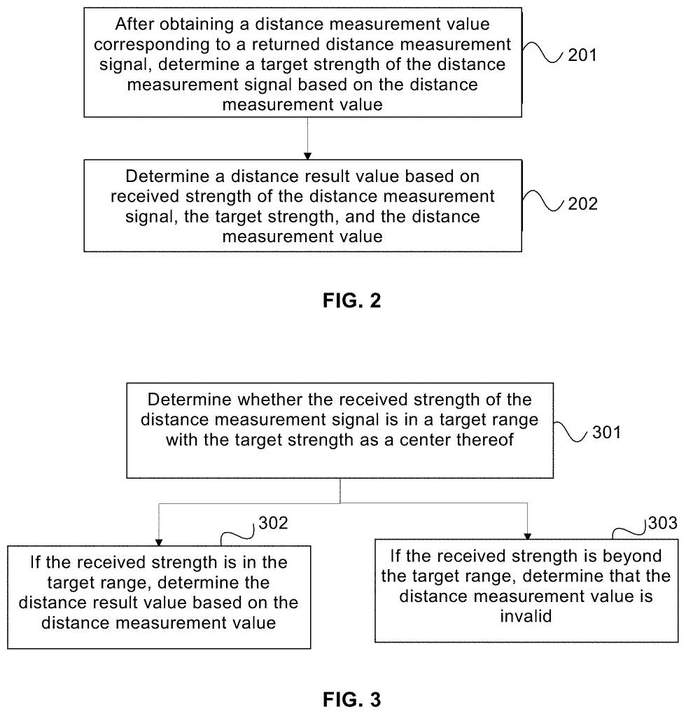

FIG. 2 is a flowchart of a first embodiment of a distance measurement method according to some exemplary embodiments of the present disclosure. The method in this embodiment may be performed by a distance measurement apparatus. Specifically, the method may be performed by one or more processors of the distance measurement apparatus. There may be one or more processors. The one or more processors work independently or cooperatively to perform the distance measurement method. As shown in FIG. 2, the method in this embodiment may include the following steps. The distance measurement apparatus may further includes at least one storage medium (e.g., a non-transitory computer-readable storage medium, such as a hard disk, SSD, CDROM, etc.) storing a set of instructions for implementing the methods of the present disclosure. The one or more processors are in communication with the at least one storage medium, where during an operation, the one or more processor executes the set of institutions to implement the methods of the present disclosure.

Step 201: After obtaining a distance measurement value corresponding to a returned distance measurement signal, determine target strength of the distance measurement signal based on the distance measurement value.

In this step, the distance measurement value may be specifically a distance measurement value determined based on the returned distance measurement signal. Herein the returned distance measurement signal may be specifically a distance measurement signal returned by an obstacle or ground, or may be a distance measurement signal returned by a particle in the air, or the like. In some exemplary embodiments, a distance measurement module may obtain the distance measurement value corresponding to the returned distance measurement signal, or a distance measurement apparatus may obtain the distance measurement value corresponding to the returned distance measurement signal. In some exemplary embodiments, when the distance measurement apparatus obtains the distance measurement value corresponding to the returned distance measurement signal, the distance measurement apparatus may contain a distance measurement module, or the distance measurement apparatus may not contain a distance measurement module.

Because a relationship exists between a relative distance and received signal strength, received signal strength satisfied by the received distance measurement signal, that is, the target strength, may be determined based on the distance measurement value. For example, as shown in FIG. 1B, when the distance measurement value is r₀, it may be determined that the target strength is E₀. A specific manner of determining the target strength based on the distance measurement value may not be limited in the present disclosure. In some exemplary embodiments, the target strength may be determined based on the distance measurement value through a preset formula, where the preset formula may reflect an existing relationship between a distance and received signal strength; or the target strength may be determined based on the distance measurement value by looking for a preset table, where the preset table may reflect an existing relationship between a distance and received signal strength.

Step 202: Determine a distance result value based on received strength of the distance measurement signal, the target strength, and the distance measurement value.

In this step, because the target strength indicates the received strength satisfied by the received distance measurement signal when the distance is the distance measurement value, the target strength and the received strength of the distance measurement signal may reflect accuracy of the distance measurement value. Specifically, when the received strength of the distance measurement signal is close to the target strength, it may indicate that accuracy of the distance measurement value is higher. Therefore, a distance result value that is more accurate than the distance measurement value is determined based on the received strength of the distance measurement signal, the target strength, and the distance measurement value. For example, based on the received strength of the distance measurement signal and the target strength, it may be determined that the distance measurement value is invalid, thereby avoiding determining a nonexistent obstacle or an incorrect height relative to ground based on an invalid distance measurement value.

In this embodiment, after the distance measurement value corresponding to the returned distance measurement signal is obtained, the target strength of the distance measurement signal may be determined based on the distance measurement value, and the distance result value may be determined based on the received strength of the distance measurement signal, the target strength, and the distance measurement value. Because the target strength and the received strength of the distance measurement signal may reflect the accuracy of the distance measurement value, the distance result value that is more accurate than the distance measurement value may be determined based on the received strength of the distance measurement signal, the target strength, and the distance measurement value. Therefore, the accuracy of a distance measurement result is improved.

FIG. 3 is a flowchart of another exemplary embodiment of a distance measurement method of the present disclosure. On a basis of the method embodiment shown in FIG. 2, the method in this exemplary embodiment mainly deals with an exemplary implementation of determining the distance result value based on the received strength of the distance measurement signal, the target strength, and the distance measurement value. As shown in FIG. 3, the method in this exemplary embodiment may include the following steps.

Step 301: Determine whether the received strength of the distance measurement signal is in a target range with the target strength as a center thereof.

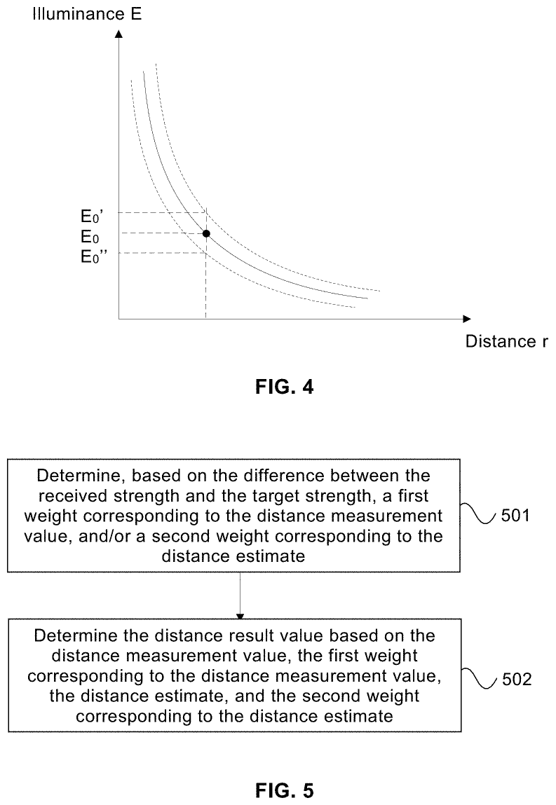

In this step, a size of the target range may be designed flexibly based on actual requirements. In some exemplary embodiments, the size of the target range may be fixed. For example, sizes of target ranges using different target strength as centers may be all the same. Alternatively, a relationship may exist between the size of the target range and the target strength. For example, the range size may be a percentage of the target strength. For example, a relationship between a distance and received strength is shown in FIG. 1B. As shown in FIG. 4, a target range with target strength E0 as a center thereof may be from E₀′ to E₀″.

It should be noted that the target range may be a full-open interval, a full-closed interval, a half-open and half-closed interval, or a half-closed and half-open interval. However, this is not limited in the present disclosure.

Step 302: If the received strength is in the target range, determine the distance result value based on the distance measurement value (i.e., after determining that the received strength is in the target range).

In this step, when the received strength of the distance measurement signal is in the target range, it may be considered that the distance measurement signal is a distance measurement signal returned after being reflected by the ground or an obstacle, rather than a distance measurement signal returned after being reflected by a particle in the air. Therefore, the distance result value may be further determined based on the distance measurement value corresponding to the distance measurement signal.

In some exemplary embodiments, the determining the distance result value based on the distance measurement value may specifically include: using the distance measurement value as the distance result value; or determining the distance result value based on the distance measurement value and a difference between the received strength and the target strength. Herein the difference may be specifically a standard deviation, a variance, a range, or the like.

The difference between the received strength and the target strength may reflect the accuracy of the distance measurement value. Specifically, the smaller the difference, the higher that accuracy; or the greater the difference, the higher the accuracy. Therefore, a distance result value of higher accuracy may be determined based on the distance measurement value and the difference reflecting accuracy of the distance measurement value. For example, a distance offset may be determined based on the difference, and a sum of the distance offset and the distance measurement value may be used as a distance result value. When the received strength minus the target strength is a positive number, the distance offset may be a negative number. When the received strength minus the target strength is a negative number, the distance offset may be a positive number. Thus, the greater the difference, the greater an absolute value of the distance offset; the smaller the difference, the smaller an absolute value of the distance offset.

Considering that distance measurement is generally a continuous process, that is, a change rule exists between a distance result value at a current moment and a distance result value at a previous moment, a distance estimate may be determined based on the distance result value at the previous moment, and further, the distance result value at the current moment may be determined based on the distance estimate. Therefore, the determining the distance result value based on the distance measurement value and a difference between the received strength and the target strength may specifically include: determining the distance result value based on the distance measurement value, the distance estimate, and the difference between the received strength and the target strength.

It should be noted that, on a basis of the exemplary embodiment shown in FIG. 2, alternatively, step 202 may specifically include: determine the distance result value based on the distance measurement value, the distance estimate, and the difference between the received strength and the target strength. To be specific, without considering whether the received strength is in the target range, the distance result value may be determined directly based on the distance measurement value, the distance estimate, and the difference. Because the difference may already reflect the accuracy of the distance measurement value, a distance result value of higher accuracy may also be determined directly based on the distance measurement value, the distance estimate, and the difference.

In some exemplary embodiments, based on the following principle: the greater the difference, the greater the importance of the distance estimate for determining the distance result value, and the smaller the importance of the distance measurement value; while the smaller the difference, the smaller the importance of the distance estimate for determining the distance result value, and the greater the importance of the distance measurement value, a specific way of determining the distance result value based on the distance measurement value, the distance estimate, and the difference between the received strength and the target strength may be designed flexibly.

Step 303: If the received strength is beyond the target range, determine that the distance measurement value is invalid (after determining that the received strength is beyond) the target range).

In this step, if the received strength of the distance measurement signal is beyond the target range, it may be considered that the distance measurement signal is a distance measurement signal returned after being reflected by a particle in the air, rather than a distance measurement signal returned after being reflected by the ground or an obstacle. Therefore, it can be determined that the distance measurement value is invalid, thereby avoiding determining a nonexistent obstacle or an incorrect height relative to the ground based on a distance measurement signal returned after being reflected by a particle in the air.

Alternatively, if the received strength is beyond the target range, the process may end.

In this exemplary embodiment, whether the received strength of the returned distance measurement signal is in the target range with the target strength as a center thereof is determined; and if the received strength is in the target range, the distance result value is determined based on the distance measurement value. This can ensure that the determined distance result value is a distance obtained based on a distance measurement signal returned after being reflected by the ground or an obstacle, rather than a distance obtained based on a distance measurement signal returned after being reflected by a particle in the air. Therefore erroneous detection can be avoided, and the accuracy of the distance measurement result is improved.

FIG. 5 is a flowchart of some exemplary embodiment of a distance measurement method of the present disclosure. On a basis of the foregoing method embodiment, the method in this exemplary embodiment mainly deals with an exemplary embodiment of determining the distance result value based on the distance measurement value, the distance estimate, and the difference between the received strength and the target strength. As shown in FIG. 5, the method in this exemplary embodiment may include the following steps.

Step 501: Determine, based on the difference between the received strength and the target strength, a first weight corresponding to the distance measurement value, and/or a second weight corresponding to the distance estimate.

In this step, the first weight may indicate the importance of the distance measurement value for determining the distance result value; and the second weight may indicate the importance of the distance estimate for determining the distance result value. Therefore, the first weight and/or the second weight (i.e., at least one of the first weight or the second weight) may be determined based on the difference.

In some exemplary embodiments, the second weight may be preset, and the first weight may be determined based on the difference between the received strength and the target strength. It should be noted that on a basis that the greater the difference, the smaller the first weight, or the smaller the difference, the greater the first weight, a specific way of determining the first weight based on the difference is not limited in the present disclosure. For example, a weight offset may be determined based on the difference, and a sum of the weight offset and the preset weight may be used as the first weight. Herein the weight offset may be a positive number, a negative number, or 0. It may be understood that on a basis that the second weight is preset, increasing the first weight may increase the importance of the distance measurement value for determining the distance result value; while decreasing the first weight may reduce the importance of the distance measurement value for determining the distance result value.

Alternatively, in some exemplary embodiments, the first weight may be preset, and the second weight may be determined based on the difference between the received strength and the target strength. It should be noted that on a basis that the greater the difference, the greater the second weight, or the smaller the difference, the smaller the second weight, a specific manner of determining the second weight based on the difference is not limited in the present disclosure. It may be understood that on a basis that the first weight is preset, increasing the second weight may reduce the importance of the distance measurement value for determining the distance result value, and decreasing the second weight may increase the importance of the distance measurement value for determining the distance result value.

Alternatively, in some exemplary embodiments, the first weight and the second weight may be determined based on the difference between the received strength and the target strength. It should be noted that on a basis that the greater the difference, the smaller the first weight and the greater the second weight; or that the smaller the difference, the greater the first weight and the smaller the second weight, that is, the difference between the received strength and the target strength is at least one of negatively correlated with the first weight or positively correlated with the second weight, a specific manner of determining the first weight based on the difference is not limited in the present disclosure.

It should be noted that, the principle that the greater the difference, the greater the importance of the distance estimate for determining the distance result value, and the smaller the importance of the distance measurement value; or that the smaller the difference, the smaller the importance of the distance estimate for determining the distance result value, and the greater the importance of the distance measurement value may be implemented regardless of whether the first weight is preset and the second weight is determined based on the difference, or the second weight is preset and the first weight is determined based on the difference, or the first weight and the second weight are both determined based on the difference.

In some exemplary embodiments, a sum of the first weight and the second weight is equal to 1. It may be understood that a normalization treatment may make the sum of the first weight and the second weight equal to 1.

Step 502: Determine the distance result value based on the distance measurement value, the first weight corresponding to the distance measurement value, the distance estimate, and the second weight corresponding to the distance estimate.

In this step, a specific manner of determining the distance result value based on the distance measurement value, the first weight, the distance estimate, and the second weight is not limited in the present disclosure. In some exemplary embodiments, the distance result value may be determined in a weighted summation or weighted averaging manner based on the distance measurement value, the first weight corresponding to the distance measurement value, the distance estimate, and the second weight corresponding to the distance estimate.

In some exemplary embodiments, when the distance measurement value is invalid, measurement may be performed again; or the distance result value may be determined based on the invalid distance measurement value. Specifically, the second weight may be set to be far greater than the first weight, so that the importance of the distance measurement value for determining the distance result value is far smaller than importance of the distance estimate for determining the distance result value. Therefore, the distance result value may be determined on a basis of weakening an impact of the distance measurement value on the distance result value.

In this exemplary embodiment, the first weight corresponding to the distance measurement value, and/or the second weight corresponding to the distance estimate are/is determined based on the difference between the received strength of the returned distance measurement signal and the target strength, and the distance result value is determined based on the distance measurement value, the first weight corresponding to the distance measurement value, the distance estimate, and the second weight corresponding to the distance estimate. On a basis of the principle that the greater the difference, the greater the importance of the distance estimate for determining the distance result value, and the smaller the importance of the distance measurement value, or that the smaller the difference, the smaller the importance of the distance estimate for determining the distance result value, and the greater the importance of the distance measurement value, the distance result value may be determined based on the distance measurement value, the received strength, and the target strength.

Alternatively, the determining the distance result value based on the distance measurement value, the distance estimate, and the difference between the received strength and the target strength may specifically include: determining the distance result value based on the distance measurement value, the distance estimate, and the difference between the received strength and the target strength by using a filtering algorithm. In some exemplary embodiments, the filtering algorithm may be specifically a Kalman filter. Specifically, the distance result value may be determined based on the distance measurement value, the distance estimate, and the difference by using the Kalman filter.

Because the measurement value is not completely accurate, measurement noise reflecting measurement inaccuracy may be introduced in the Kalman filter. Generally, it is assumed that the measurement noise is white Gaussian noise. In addition, because the difference may reflect accuracy of the distance measurement value, in some exemplary embodiments, the difference may be used to generate measurement noise. Specifically, the difference may be a variance; and correspondingly, the determining the distance result value based on the distance measurement value, the distance estimate, and the difference by using the Kalman filter includes: using the distance measurement value as a measurement value input to the Kalman filter, using the distance estimate as an estimate input to the Kalman filter, using the difference as a variance of noise of the Kalman filter, and using an output of the Kalman filter as the distance result value.

In some exemplary embodiments, when the distance measurement value is invalid, a greater preset difference may be used as the difference between the received strength and the target strength, and the distance result value is determined based on the Kalman filter. Therefore, the distance result value can be determined on a basis of weakening an impact of the distance measurement value on the distance result value. The preset difference may be far greater than a maximum difference between the received strength and the target strength when the distance measurement value is invalid.

In some exemplary embodiments, the distance estimate may be determined by a distance measurement apparatus. In some exemplary embodiments, the distance estimate may be determined based on data of an inertial measurement unit (IMU). In some exemplary embodiments, the method may further include: determining the distance estimate based on the data of the IMU and a distance result value determined at a previous moment. In some exemplary embodiments, the distance result value determined at the previous moment may be specifically a distance result value determined at one previous moment, or an average value of distance result values determined at two previous moments. The IMU may measure an angular speed and acceleration of an object in a three-dimensional space, and obtain a posture of the object on this basis.

Taking measurement of a relative height as an example, a speed in a vertical direction may be determined based on the data of the IMU, and the distance estimate may be then determined based on the speed in the vertical direction and the distance result value at the previous moment. Taking measurement of a relative distance from an obstacle that is directly in front as an example, a speed in a horizontal direction may be determined based on the data of the IMU, and the distance estimate may be obtained based on the speed in the horizontal direction and the distance result value at the previous moment. Using measurement of a relative distance from an obstacle that is down in front as an example, speeds in a horizontal direction and a vertical direction may be determined based on the data of the IMU, and the distance estimate may be obtained based on the speeds in the horizontal direction and the vertical direction and the distance result value at the previous moment.

In some exemplary embodiments, motion estimation may be performed based on IMU pre-integration. In some exemplary embodiments, the following formula (6) to formula (11) may be used to implement motion estimation:

pₖ₊₁=pₖ+vₖΔt+½(R_{wi}(aₘ−bₐ)+g)×t² formula (6)

vₖ₊₁=vₖ+(R_{wi}(aₘ−bₐ)+g)Δt formula (7)

qₖ₊₁=qₖ⊗Δq formula (8)

q=q{(ω−b_{ω})Δt} formula (9)

(bₐ)ₖ₊₁=(bₐ)ₖ formula (10)

(b_{ω})ₖ₊₁=(b_{ω})ₖ formula (11)

In the formula (6) to the formula (11), Pₖ₊₁ is a location at the current moment, vₖ₊₁ is a speed at the current moment, qₖ₊₁ is a posture 4-tuple at the current moment, (bₐ)ₖ₊₁ is a zero-axis deviation of an accelerometer at the current moment, (b_{ω})ₖ₊₁ is a zero-axis deviation of a gyroscope at the current moment, pₖ is a location at a previous moment, vₖ is a speed at the previous moment, qₖ is a posture 4-tuple at the previous moment, (bₐ)ₖ is a zero-axis deviation of the accelerometer at the previous moment, (b_{ω})ₖ is a zero-axis deviation of the gyroscope at the previous moment, Δt is a time difference between the previous moment and the current moment, where given 20 Hz, Δt can be approximately calculated as 50 ms, aₘ is a reading of the accelerometer at the current moment, g is gravity acceleration, ω is a reading of the gyroscope at the current moment, Δq is a posture difference between the current moment and the previous moment, and R_{wi} is a matrix for conversion from an IMU coordinate to a world coordinate.

Therefore, a height change Δh between the current moment and the previous moment may be obtained, as shown in the following formula (12), where a speed v_{z} in the vertical direction is shown in the following formula (13):

Δh=p^{(z)} formula (12)

v_{z}=\dot{p}^{(z)} formula (13)

In the formula (12) and the formula (13), z is a direction on a z-axis.

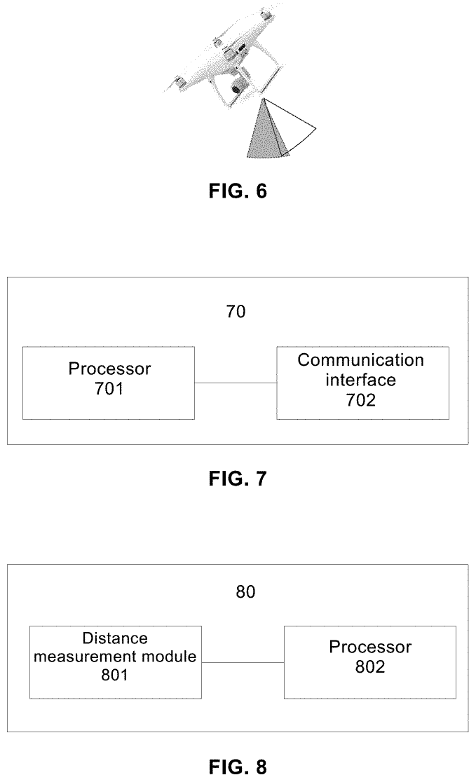

The transmission direction of the distance measurement signal may be affected by the posture of a device (such as an unmanned aerial vehicle) on which the distance measurement apparatus is located. Considering a scenario in which the distance measurement value is invalid when the device is in a particular posture, as shown in FIG. 6, the white triangular area is an actually measured area, but what is concerned in the measurement is a vertical height relative to ground, that is, the measurement in the gray triangular area. In this case, the distance measurement value may be affected by the posture of the unmanned aerial vehicle. For example, when the height relative to the ground is measured, if a tilt angle of the unmanned aerial vehicle is too large, the distance measurement signal may hit a wall, a building, or the like other than the ground, causing the measurement result to be invalid. It should be noted that a multi-rotor unmanned aerial vehicle is used as an example in FIG. 6.

Therefore, in the foregoing embodiment, before step 202, the method may further include: determining whether the posture of the unmanned aerial vehicle satisfies a preset posture condition; if the posture of the unmanned aerial vehicle satisfies the preset posture condition, determining the distance result value based on the received strength of the distance measurement signal, the target strength, and the distance measurement value. If the posture of the unmanned aerial vehicle does not satisfy the preset posture condition, the process ends or the distance measurement value is invalid. Herein the preset posture condition may be a posture condition that the posture of the unmanned aerial vehicle should satisfy when the distance measurement value is valid. For example, ∥ω−b_{ω}∥₂<ωₜₕ may indicate that the posture of the unmanned aerial vehicle satisfies the preset posture condition when the height relative to the ground is measured, where ω is the reading of the gyroscope at the current moment, b_{ω} is the zero-axis deviation of the accelerometer, and ωₜₕ is a reading threshold.

Herein if the posture of the unmanned aerial vehicle satisfies the preset posture condition, the distance result value is determined based on the received strength of the distance measurement signal, the target strength, and the distance measurement value. This can avoid erroneous detection caused by an inappropriate posture of the unmanned aerial vehicle, and therefore can improve the accuracy of the distance measurement result.

FIG. 7 is a schematic structural diagram of a distance measurement apparatus according to some exemplary embodiments of the present disclosure. As shown in FIG. 7, a distance measurement apparatus 70 provided includes a processor 701 and a communication interface 702.

after obtaining, through the communication interface 702, a distance measurement value corresponding to a returned distance measurement signal, the processor 701 is configured to determine target strength of the distance measurement signal based on the distance measurement value; and the processor 701 is further configured to determine a distance result value based on received strength of the distance measurement signal, the target strength, and the distance measurement value.

In some exemplary embodiments, that the processor 701 is configured to determine a distance result value based on received strength of the distance measurement signal, the target strength, and the distance measurement value specifically includes:

determining whether the received strength of the distance measurement signal is in a target range with the target strength as a center thereof; and if the received strength is in the target range (i.e., after determining that the received strength is in the target range), determining the distance result value based on the distance measurement value.

In some exemplary embodiments, that the processor 701 is configured to determine a distance result value based on received strength of the distance measurement signal, the target strength, and the distance measurement value specifically includes:

determining whether the received strength of the distance measurement signal is in a target range with the target strength as a center thereof; and if the received strength is beyond the target range (i.e., after determining that the received strength is beyond the target range), determining that the distance measurement value is invalid.

In some exemplary embodiments, that the processor 701 is configured to determine the distance result value based on the distance measurement value specifically includes:

using the distance measurement value as the distance result value.

In some exemplary embodiments, the processor 701 is specifically configured to:

determine the distance result value based on the distance measurement value, a distance estimate, and a difference between the received strength and the target strength.

In some exemplary embodiments, that the processor 701 is configured to determine the distance result value based on the distance measurement value, a distance estimate, and a difference between the received strength and the target strength specifically includes:

determining, based on the difference between the received strength and the target strength, a first weight corresponding to the distance measurement value, and/or a second weight corresponding to the distance estimate (i.e., at least one of a first weight corresponding to the distance measurement value, or a second weight corresponding to the distance estimate); and determining the distance result value based on the distance measurement value, the first weight corresponding to the distance measurement value, the distance estimate, and the second weight corresponding to the distance estimate.

In some exemplary embodiments, that the processor 701 is configured to determine the distance result value based on the distance measurement value, the first weight corresponding to the distance measurement value, the distance estimate, and the second weight corresponding to the distance estimate specifically includes:

determining the distance result value through a weighted summation based on the distance measurement value, the first weight corresponding to the distance measurement value, the distance estimate, and the second weight corresponding to the distance estimate.

In some exemplary embodiments, the smaller the difference, the greater the first weight, and/or the smaller the second; or the greater the difference, the smaller the first weight, and/or the greater the second weight, that is, the difference between the received strength and the target strength is at least one of negatively correlated with the first weight or positively correlated with the second weight.

In some exemplary embodiments, a sum of the first weight and the second weight is equal to 1.

In some exemplary embodiments, that the processor 701 is configured to determine the distance result value based on the distance measurement value, a distance estimate, and a difference between the received strength and the target strength specifically includes:

determining the distance result value based on the distance measurement value, the distance estimate, and the difference through a Kalman filter.

In some exemplary embodiments, that the processor 701 is configured to determine the distance result value based on the distance measurement value, the distance estimate, and the difference through a Kalman filter specifically includes:

using the distance measurement value as a measurement value input to the Kalman filter, using the distance estimate as an estimate input to the Kalman filter, using the difference as a variance of noise of the Kalman filter, and using an output of the Kalman filter as the distance result value.

In some exemplary embodiments, the processor 701 is further configured to determine the distance estimate based on data of an inertial measurement unit (IMU) and a distance result value determined at a previous moment.

In some exemplary embodiments, the processor 701 is further configured to:

determine whether a posture of an unmanned aerial vehicle satisfies a preset posture condition; and

if the posture of the unmanned aerial vehicle satisfies the preset posture condition, perform the step of determining a distance result value based on received strength of the distance measurement signal, the target strength, and the distance measurement value.

In some exemplary embodiments, the processor 701 is further configured to: if the posture of the unmanned aerial vehicle does not satisfy the preset posture condition, determine that the distance measurement value is invalid.

The distance measurement apparatus in this exemplary embodiment may be configured to perform the technical solution of the exemplary method embodiments shown in FIG. 2, FIG. 3, or FIG. 5. The implementation principles and technical effects thereof are similar, and will not be described again herein.

FIG. 8 is a schematic structural diagram of a distance measurement apparatus according to some exemplary embodiments of the present disclosure. As shown in FIG. 8, a distance measurement apparatus 80 includes a distance measurement module 801 and a processor 802, where:

the distance measurement module 801 is configured to determine, based on a returned distance measurement signal, a distance measurement value corresponding to the distance measurement signal;

the processor 802 is configured to determine target strength of the distance measurement signal based on the distance measurement value after the distance measurement module 801 obtains the distance measurement value corresponding to the distance measurement signal; and

the processor 802 is further configured to determine a distance result value based on received strength of the distance measurement signal, the target strength, and the distance measurement value.

In some exemplary embodiments, that the processor 802 is configured to determine a distance result value based on received strength of the distance measurement signal, the target strength, and the distance measurement value specifically includes:

determining whether the received strength of the distance measurement signal is in a target range with the target strength as a center thereof; and

if the received strength is in the target range, determining the distance result value based on the distance measurement value.

In some exemplary embodiments, that the processor 802 is configured to determine a distance result value based on received strength of the distance measurement signal, the target strength, and the distance measurement value specifically includes:

determining whether the received strength of the distance measurement signal is in a target range with the target strength as a center thereof; and

if the received strength is beyond the target range, determining that the distance measurement value is invalid.

In some exemplary embodiments, that the processor 802 is configured to determine the distance result value based on the distance measurement value specifically includes:

using the distance measurement value as the distance result value.

In some exemplary embodiments, the processor 802 is specifically configured to:

determine the distance result value based on the distance measurement value, a distance estimate, and a difference between the received strength and the target strength.

In some exemplary embodiments, that the processor 802 is configured to determine the distance result value based on the distance measurement value, a distance estimate, and a difference between the received strength and the target strength specifically includes:

determining, based on the difference between the received strength and the target strength, a first weight corresponding to the distance measurement value, and/or a second weight corresponding to the distance estimate (i.e., at least one of a first weight corresponding to the distance measurement value, or a second weight corresponding to the distance estimate); and

determining the distance result value based on the distance measurement value, the first weight corresponding to the distance measurement value, the distance estimate, and the second weight corresponding to the distance estimate.

In some exemplary embodiments, that the processor 802 is configured to determine the distance result value based on the distance measurement value, the first weight corresponding to the distance measurement value, the distance estimate, and the second weight corresponding to the distance estimate specifically includes:

determining the distance result value through a weighted summation based on the distance measurement value, the first weight corresponding to the distance measurement value, the distance estimate, and the second weight corresponding to the distance estimate.

In some exemplary embodiments, the smaller the difference, the greater the first weight, and/or the smaller the second weight; or the greater the difference, the smaller the first weight, and/or the greater the second weight, that is, the difference between the received strength and the target strength is at least one of negatively correlated with the first weight or positively correlated with the second weight.

In some exemplary embodiments, a sum of the first weight and the second weight is equal to 1.

In some exemplary embodiments, that the processor 802 is configured to determine the distance result value based on the distance measurement value, a distance estimate, and a difference between the received strength and the target strength specifically includes:

determining the distance result value based on the distance measurement value, the distance estimate, and the difference through a Kalman filter.

In some exemplary embodiments, the difference is a variance; and

that the processor 802 is configured to determine the distance result value based on the distance measurement value, the distance estimate, and the difference through a Kalman filter specifically includes:

using the distance measurement value as a measurement value input to the Kalman filter, using the distance estimate as an estimate input to the Kalman filter, using the difference as a variance of noise of the Kalman filter, and using an output of the Kalman filter as the distance result value.

In some exemplary embodiments, the processor 802 is further configured to determine the distance estimate based on data of an inertial measurement unit (IMU) and a distance result value determined at a previous moment.

In some exemplary embodiments, the processor 802 is further configured to:

determine whether a posture of an unmanned aerial vehicle satisfies a preset posture condition; and

if the posture of the unmanned aerial vehicle satisfies the preset posture condition, perform the step of determining a distance result value based on received strength of the distance measurement signal, the target strength, and the distance measurement value.

In some exemplary embodiments, the processor 802 is further configured to: if the posture of the unmanned aerial vehicle does not satisfy the preset posture condition, determine that the distance measurement value is invalid.

In some exemplary embodiments, the distance measurement module 801 includes at least one of the following:

an ultrasonic distance measurement module, a time of flight (ToF) distance measurement module, an infrared distance measurement module, a lidar distance measurement module, and a millimeter-wave radar distance measurement module.

The distance measurement apparatus in this exemplary embodiment may be configured to perform the technical solutions of the method embodiments shown in FIG. 2, FIG. 3, or FIG. 5. The implementation principles and technical effects thereof are similar, and will not be described again herein.

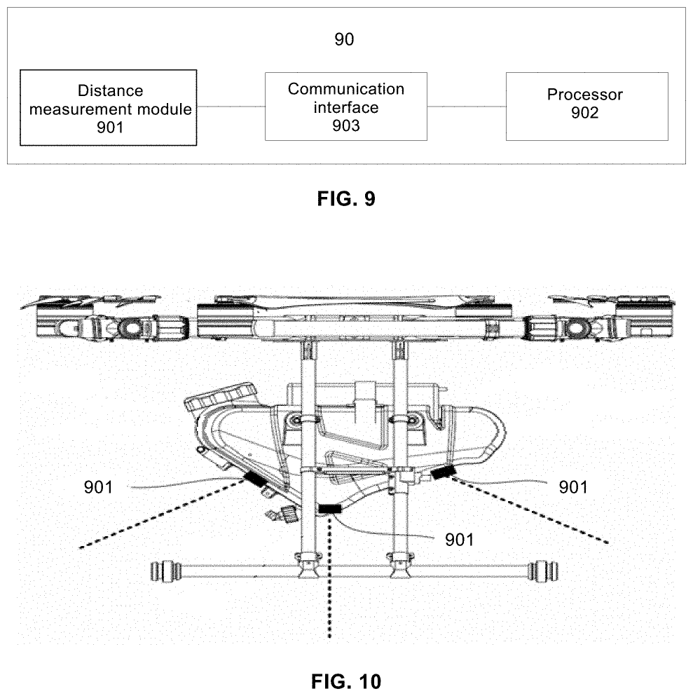

FIG. 9 is a schematic structural diagram of an unmanned aerial vehicle according to some exemplary embodiments of the present disclosure. FIG. 10 is a physical structural diagram of an unmanned aerial vehicle according to some exemplary embodiments of the present disclosure. As shown in FIG. 9 and FIG. 10, the unmanned aerial vehicle in this embodiment includes a distance measurement module 901, a processor 902, and a communication interface 903, where:

the distance measurement module 901 is configured to determine, based on a returned distance measurement signal, a distance measurement value corresponding to the distance measurement signal;

the processor 902 is configured to determine target strength of the distance measurement signal based on the distance measurement value after obtaining, from the distance measurement module 901 through the communication interface 903, the distance measurement value corresponding to the distance measurement signal; and

the processor 902 is further configured to determine a distance result value based on received strength of the distance measurement signal, the target strength, and the distance measurement value.

In some exemplary embodiments, that the processor 902 is configured to determine a distance result value based on received strength of the distance measurement signal, the target strength, and the distance measurement value specifically includes:

determining whether the received strength of the distance measurement signal is in a target range with the target strength as a center thereof; and if the received strength is in the target range (i.e., after determining that the received strength is in the target range), determining the distance result value based on the distance measurement value.

In some exemplary embodiments, that the processor 902 is configured to determine a distance result value based on received strength of the distance measurement signal, the target strength, and the distance measurement value specifically includes:

determining whether the received strength of the distance measurement signal is in a target range with the target strength as a center thereof; and if the received strength is beyond the target range (after determining that the received strength is beyond) the target range, determining that the distance measurement value is invalid.

In some exemplary embodiments, that the processor 902 is configured to determine the distance result value based on the distance measurement value specifically includes:

using the distance measurement value as the distance result value.

In some exemplary embodiments, the processor 902 is specifically configured to:

determine the distance result value based on the distance measurement value, a distance estimate, and a difference between the received strength and the target strength.

In some exemplary embodiments, that the processor 902 is configured to determine the distance result value based on the distance measurement value, a distance estimate, and a difference between the received strength and the target strength specifically includes:

determining, based on the difference between the received strength and the target strength, a first weight corresponding to the distance measurement value, and/or a second weight corresponding to the distance estimate (i.e., at least one of a first weight corresponding to the distance measurement value, or a second weight corresponding to the distance estimate); and

determining the distance result value based on the distance measurement value, the first weight corresponding to the distance measurement value, the distance estimate, and the second weight corresponding to the distance estimate.

In some exemplary embodiments, that the processor 902 is configured to determine the distance result value based on the distance measurement value, the first weight corresponding to the distance measurement value, the distance estimate, and the second weight corresponding to the distance estimate specifically includes:

determining the distance result value through a weighted summation based on the distance measurement value, the first weight corresponding to the distance measurement value, the distance estimate, and the second weight corresponding to the distance estimate.

In some exemplary embodiments, the smaller the difference, the greater the first weight, and/or the smaller the second weight; or the greater the difference, the smaller the first weight, and/or the greater the second weight, that is, the difference between the received strength and the target strength is at least one of negatively correlated with the first weight or positively correlated with the second weight.

In some exemplary embodiments, a sum of the first weight and the second weight is equal to 1.

In some exemplary embodiments, that the processor 902 is configured to determine the distance result value based on the distance measurement value, a distance estimate, and a difference between the received strength and the target strength specifically includes:

determining the distance result value based on the distance measurement value, the distance estimate, and the difference through a Kalman filter.

In some exemplary embodiments, the difference is a variance; and

that the processor 902 is configured to determine the distance result value based on the distance measurement value, the distance estimate, and the difference through a Kalman filter specifically includes:

using the distance measurement value as a measurement value input to the Kalman filter, using the distance estimate as an estimate input to the Kalman filter, using the difference as a variance of noise of the Kalman filter, and using an output of the Kalman filter as the distance result value.

In some exemplary embodiments, the processor 902 is further configured to determine the distance estimate based on data of an inertial measurement unit IMU and a distance result value determined at a previous moment.

In some exemplary embodiments, the processor 902 is further configured to:

determine whether a posture of the unmanned aerial vehicle satisfies a preset posture condition; and

if the posture of the unmanned aerial vehicle satisfies the preset posture condition, perform the step of determining a distance result value based on received strength of the distance measurement signal, the target strength, and the distance measurement value.

In some exemplary embodiments, the processor 902 is further configured to: if the posture of the unmanned aerial vehicle does not satisfy the preset posture condition, determine that the distance measurement value is invalid.

In some exemplary embodiments, the distance measurement module includes at least one of the following: an ultrasonic distance measurement module, a time of flight (ToF) distance measurement module, an infrared distance measurement module, a lidar distance measurement module, and a millimeter-wave radar distance measurement module.

In FIG. 10, the distance measurement module is mounted on a load of the unmanned aerial vehicle, and the unmanned aerial vehicle includes three distance measurement modules, where one distance measurement module transmits a distance measurement signal vertically down, one distance measurement module transmits a distance measurement signal obliquely forward down, and one distance measurement module transmits a distance measurement signal obliquely backward down. The distance measurement signals are indicated by dotted lines in FIG. 10. The load may be, for example, a water tank. Herein types of the three distance measurement modules may be the same, for example, all ToF distance measurement modules, or may be different, for example, two ToF distance measurement modules, and one ultrasonic distance measurement module.

It should be noted that FIG. 10 shows only an exemplary physical structural diagram of an unmanned aerial vehicle, and does not limit the structure of the unmanned aerial vehicle. The structure of the unmanned aerial vehicle is not specifically limited in the present disclosure.

The unmanned aerial vehicle in this embodiment may be configured to perform the technical solution of the exemplary method embodiment shown in FIG. 2, FIG. 3, or FIG. 5. The implementation principles and technical effects thereof are similar, and are not described again herein.

A person of ordinary skill in the art may understand that all or some of the steps of the method embodiments may be implemented by a program instructing relevant hardware. The program may be stored in a computer-readable storage medium. When the program is executed, the steps of the method embodiments are performed. The foregoing storage medium includes: any medium that can store program code, such as a ROM, a RAM, a magnetic disk, or an optical disk.

Finally, it should be noted that the foregoing embodiments are merely intended for describing the technical solutions of the present disclosure, but not for limiting the present disclosure. Although the present disclosure is described in detail with reference to the above exemplary embodiments, a person of ordinary skill in the art should understand that modifications or equivalent replacements may be made to the technical solutions described in these embodiments or some or all technical features thereof, without departing from the scope of the technical solutions of the embodiments of the present disclosure.

What is claimed is:

1. A distance measurement apparatus, comprising:
a distance measurement module to obtain, based on a returned distance measurement signal, a distance measurement value corresponding to the distance measurement signal; and
a processor, to:
determine target strength of the distance measurement signal based on the distance measurement value after the distance measurement module obtaining the distance measurement value corresponding to the distance measurement signal, and
determine a distance result value based on received strength of the distance measurement signal, the target strength, and the distance measurement value.

2. The apparatus according to claim 1, wherein to determine the distance result value based on the received strength of the distance measurement signal, the target strength, and the distance measurement value, the processor further:
after determining that the received strength is in a target range, determines the distance result value based on the distance measurement value.

3. The apparatus according to claim 1, wherein to determine a distance result value based on the received strength of the distance measurement signal, the target strength, and the distance measurement value, the processor further:
after determining that the received strength is beyond a target range, determines that the distance measurement value is invalid.

4. The apparatus according to claim 2, wherein to determine the distance result value based on the distance measurement value, the processor further:
uses the distance measurement value as the distance result value.

5. The apparatus according to claim 1, wherein the processor further:
determines the distance result value based on the distance measurement value, a distance estimate, and a difference between the received strength and the target strength.

6. An unmanned aerial vehicle, comprising:
a distance measurement module to obtain, based on a returned distance measurement signal, a distance measurement value corresponding to the distance measurement signal;
a processor to:
determine target strength of the distance measurement signal based on the distance measurement value after obtaining, from the distance measurement module through the communication interface, the distance measurement value corresponding to the distance measurement signal, and
determine a distance result value based on received strength of the distance measurement signal, the target strength, and the distance measurement value; and
a communication interface.

7. The unmanned aerial vehicle according to claim 6, wherein to determine a distance result value based on the received strength of the distance measurement signal, the target strength, and the distance measurement value, the processor further:
after determining that the received strength is in a target range, determines the distance result value based on the distance measurement value.

8. The unmanned aerial vehicle according to claim 6, wherein to determine the distance result value based on the received strength of the distance measurement signal, the target strength, and the distance measurement value, the processor further:
after determining that the received strength is beyond a target range, determines that the distance measurement value is invalid.

9. The unmanned aerial vehicle according to claim 7, wherein to determine the distance result value based on the distance measurement value, the processor further:
uses the distance measurement value as the distance result value.

10. The unmanned aerial vehicle according to claim 6, wherein the processor further:
determines the distance result value based on the distance measurement value, a distance estimate, and a difference between the received strength and the target strength.

11. The unmanned aerial vehicle according to claim 10, wherein to determine the distance result value based on the distance measurement value, the distance estimate, and the difference between the received strength and the target strength, the processor further:
determines, based on the difference between the received strength and the target strength, at least one of a first weight corresponding to the distance measurement value, or a second weight corresponding to the distance estimate; and
determines the distance result value based on the distance measurement value, the first weight corresponding to the distance measurement value, the distance estimate, and the second weight corresponding to the distance estimate.

12. The unmanned aerial vehicle according to claim 11, wherein to determine the distance result value based on the distance measurement value, the first weight corresponding to the distance measurement value, the distance estimate, and the second weight corresponding to the distance estimate, the processor further:
determines the distance result value through a weighted summation based on the distance measurement value, the first weight corresponding to the distance measurement value, the distance estimate, and the second weight corresponding to the distance estimate.

13. The unmanned aerial vehicle according to claim 11, wherein the difference between the received strength and the target strength is at least one of negatively correlated with the first weight or positively correlated with the second weight.

14. The unmanned aerial vehicle according to claim 11, wherein a sum of the first weight and the second weight is equal to 1.

15. The unmanned aerial vehicle according to claim 10, wherein to determine the distance result value based on the distance measurement value, the distance estimate, and the difference between the received strength and the target strength, the processor further:
determines the distance result value based on the distance measurement value, the distance estimate, and the difference between the received strength and the target strength through a Kalman filter.

16. The unmanned aerial vehicle according to claim 10, wherein the processor further determines the distance estimate based on data of an inertial measurement unit (IMU) and a distance result value determined at a previous moment.

17. The unmanned aerial vehicle according to claim 16, wherein the processor further:
after determining that the posture of the unmanned aerial vehicle satisfies a preset posture condition, determines the distance result value based on the received strength of the distance measurement signal, the target strength, and the distance measurement value.

18. The unmanned aerial vehicle according to claim 17, wherein the processor further determines that the distance measurement value is invalid after determining that the posture of the unmanned aerial vehicle does not satisfy the preset posture condition.

19. The unmanned aerial vehicle according to claim 6, wherein the distance measurement module includes at least one of:
an ultrasonic distance measurement module,
a time of flight (ToF) distance measurement module,
an infrared distance measurement module,
a lidar distance measurement module, or
a millimeter-wave radar distance measurement module.

20. A distance measurement method, comprising:
determining, by a processor of a distance measurement apparatus, target strength of a distance measurement signal based on a distance measurement value, after obtaining the distance measurement value corresponding to a returned distance measurement signal; and
determining a distance result value based on a received strength of the distance measurement signal, the target strength, and the distance measurement value.
